(19) United States
(12) Patent Application Publication
(10) Pub. No.: US 2007/0083586 A1
(43) Pub. Date: Apr. 12, 2007

(54) System and method for optimized reciprocal operations

(76) Inventors: Jianjun Luo, Cupertino, CA (US); David K. Chin, Los Altos, CA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/249,655

(22) Filed: Oct. 12, 2005

(51) Int. Cl. H04L 9/30; G06F 7/38; H04L 9/00; H04K 1/00

(52) U.S. Cl. 708/502; 380/30

(57) ABSTRACT

A method and apparatus for calculating a reciprocal of an integer using a modified Newton Raphson method using one's complements instead of two's complements. The method includes determining a required precision; determining a number of iterations T responsive to the required precision; normalizing N into d; obtaining initial approximation of 1/d=R[0]; refining reciprocal approximation by the modified Newton Raphson operation using ones complements; truncating final iteration result R[T] responsive to the required precision; denormalizing R[T]; and outputting the reciprocal R.

### TECHNICAL FIELD

This application relates to systems and method for arithmetic operations, more specifically, to a hardware-based reciprocal operation.

### BACKGROUND

A variety of cryptographic techniques are known for securing transactions in data communication. For example, the SSL protocol provides a mechanism for securely sending data between a server and a client. Briefly, the SSL provides a protocol for authenticating the identity of the server and the client and for generating an asymmetric (private-public) key pair. The authentication process provides the client and the server with some level of assurance that they are communicating with the entity with which they intended to communicate. The key generation process securely provides the client and the server with unique cryptographic keys that enable each of them, but not others, to encrypt or decrypt data they send to each other via the network.

Public key cryptography is a form of cryptography which allows users to communicate securely without a previously agreed shared secret key. Public key cryptography provides secure communication over an insecure channel, without having to agree upon a key in advance.

Public key encryption algorithms, such as Rivest Shamir and Adleman (RSA), DSA, Diffie-Hellman (DH), and others, typically use a pair of two related keys. One key is private and must be kept secret, while the other is made public and can be publicly distributed. Public-key cryptography is also referred to as asymmetric-key cryptography because not all parties hold the same information.

Public key cryptography has two main applications. First, is encryption, that is, keeping the contents of messages secret. Second, digital signatures (DS) can be implemented using public key techniques. Typically, public key techniques are much more computationally intensive than symmetric algorithms.

FIG. 1 illustrates a typical personal computer-based application of public keys. As shown, a client device stores its private key (Ka-priv) 114 in a system memory 106 of a computer 100. To reduce the complexity of FIG. 1, the entire computer 100 is not shown. When a session is initiated, the server encrypts the session key (Ks) 128 using the client's public key (Ka-pub) then, sends the encrypted session key (Ks)Ka-pub 122 to the client. As represented by lines 116 and 124, the client then retrieves its private key (Ka-priv) 114 and the encrypted session key 122 from the system memory 106 via the PCI bus 108 and loads them into a public key accelerator 110 in an accelerator module or card 102. The public key accelerator 110 uses this downloaded private key (Ka) 120 to decrypt the encrypted session key 122. As represented by line 126, the public key accelerator 110 then loads the clear text session key (Ks) 128 into the system memory 106.

When the server needs to send sensitive data to the client during the session the server encrypts the data using the session key (Ks) and loads the encrypted data [data]Ks 104 into system memory. When a client application needs to access the plaintext (unencrypted) data, it may load the session key 128 and the encrypted data 104 into a symmetric algorithm engine (e.g., 3DES, AES, etc.) 112 as represented by lines 130 and 134, respectively. The symmetric algorithm engine 112 uses the loaded session key 132 to decrypt the encrypted data and, as represented by line 136, loads plaintext data 138 into the system memory 106. At this point, the client application may use the data 138. The client's private key (Ka-priv) 114 may be stored in the clear (e.g., unencrypted) in the system memory 106 and it may be transmitted in the clear across the PCI bus 108.

Hardware components such as an encryption engine may perform asymmetric key algorithms (e.g., DSA, RSA, Diffie-Hellman, etc.), key exchange protocols, symmetric key algorithms (e.g., 3DES, AES, etc.), or authentication algorithms (e.g., HMAC-SHA1, etc.). However, the performance of hardware-based public key encryption engines (PKE) are determined by efficient implementation of modular arithmetic, specially modular reduction required in public key encryption. A public key operation requires intensive modular arithmetic, which in turn, requires modular reduction. One technique used for modular reduction is Barrett algorithm, described in P. Barrett, Implementing the Rivest Shamir and Adleman Public Key Encryption Algorithm on a Standard Signal Processor, Advances in Cryptology-CRYPTO '86 Proceedings, Springer-Verlag, 1987, pp. 311-323, the content of which is hereby expressly incorporated by reference. Though, Barrett algorithm is typically best for small arguments.

However, to achieve a more robust security, long size keys are desirable. Long size keys require long integer modular arithmetic that is not best suited for a regular Barrett algorithm. Therefore, there is a need for a high performance hardware-based system and method for public key operations which allows large key sizes.

### SUMMARY OF THE INVENTION

In one embodiment, the invention is a method for calculating a reciprocal R of an integer N of length k*256 bit. The method includes determining a required precision; determining a number of iterations T responsive to the required precision; normalizing N into d so that N=d*2^{-s}*2^{K}, 1≦d<2 (d=1.b₁b₂b₃ . . . b_{K}) , where N=(Nₖ₋₁Nₖ₋₂ . . . N₀)_{b} is modulus before normalization, d is an intermediate result of modulus after normalization, and s is normalize shift count; obtaining initial approximation of 1/d=R[0], where R is reciprocal at different iterations of a modified Newton Raphson operation; refining reciprocal approximation by the modified Newton Raphson operation using ones complements; truncating final iteration result R[T] responsive to the required precision; denormalizing R[T]; and outputting the reciprocal R.

In one embodiment, the invention is a system for accelerating calculation of a reciprocal of an integer N. The system includes an input buffer for receiving an input including a long integer N and a required precision; a parser for decoding the received input to determine the size of the integer N, the number of iterations of a modified Newton Raphson operation, and the number of truncations for each iteration; a lookup table for obtaining an initial reciprocal seed 1/d; a memory for storing the input integer N, intermediate normalized d of N, and intermediate and final results of the reciprocal calculation in pre-assigned locations; a microcode generation module for generating microcode on the fly responsive to the required precision, the stored integer N, and the intermediate results; an execution unit for executing the generated microcode in a single-cycle based pipeline structure to generate the reciprocal of the integer N; and an output buffer for outputting the reciprocal.

### BRIEF DESCRIPTION OF THE DRAWINGS

FIG. 1 illustrates a typical personal computer-based application of public keys;

FIG. 1A is an exemplary process flow diagram for calculating a reciprocal R of an integer N, according to one embodiment of the present invention;

FIG. 2 is an exemplary block diagram of a PKE, according to one embodiment of the present invention;

FIG. 3 is an exemplary block diagram of a PKE core, according to one embodiment of the present invention;

FIG. 4 is an exemplary microcode instruction format, according to one embodiment of the present invention;

FIG. 5 is an exemplary block diagram depicting the memory structure, according to one embodiment of the present invention;

FIG. 6 is an exemplary process flow for a modular operation, according to one embodiment of the present invention; and

FIG. 7 shows different pipeline stages in an exemplary PKE core, according to one embodiment of the present invention.

### DETAILED DESCRIPTION

In one embodiment, the present invention is a method and apparatus for high performance public key operations which allows key sizes longer than 4K bit, without substantial degradation in performance. The present invention provides variations of modular reduction methods based on standard Barrett algorithm (modified Barrett algorithm) to accommodate RSA, DSA and other public key operation. The invention includes a unique microcode architecture for supporting highly pipelined long integer (usually several thousand bits) operations without condition checking and branching overhead and an optimized data-independent pipelined scheduling for major public key operations like, RSA, DSA, DH, and the like. The microcode is generated on the fly, that is, the microcode is not preprogrammed but instead, is generated inside the hardware after public key operation type, size and operands are given as input. Once a microcode instruction is generated, it's decoded and executed immediately in a pipelined fashion. No memory storage is needed for the generated microcode. Furthermore, the generated microcode does not contain any condition checking or jumps. This way, the microcode is optimized to perform long integer modular arithmetic operations in a single-cycle based pipeline architecture.

In one embodiment, the invention includes a high-performance Multiplier/Adder (MAC) core to support specially designed microcode instructions, a unique memory structure and address mapping to support up to three Read and one Write operations simultaneously using standard dual port memories (e.g., a dual port RAM), and an auto microcode generating module that generates microcode for different size of operands on the fly.

The invention utilizes optimized hardware modular arithmetic algorithms for public key operations, high-performance hardware reciprocal algorithms for different precision requirements, and an optimized Extended Euclid algorithm for computing modular inverse or long integer divisions required in the public key operations.

Three modified Barrett algorithms have been devised that are capable of handling long integer modular arithmetic. All long integer modular arithmetic except modular addition and modular subtraction use the modified Barrett algorithms. All these supported modular arithmetic including modular reduction, modular addition, modular subtraction, modular inverse, modular multiplication, modular squaring, modular exponentiation, double modular exponentiation for DH, RSA, and DSA are summarized below.

1. Modular Reduction

```
  Modified Barrett's Method 0: (for most public key
operations)
  Input: x=(x₂ₖx₂ₖ₋₁...x₁x₀)_{b}, m=(mₖ₋₁...m₁m₀)_{b}, b=2²⁵⁶, mₖ₋₁≠0,
  0≦x₂ₖ<2⁴.
  Output: r=x mod m
  u=└b^{2k+1}/m┘, q1=└x/b^{k-1}┘, q2=q1*u, q3=└q2/b^{k+2}┘.
  r1=x mod b^{k+1}, r2=q3*m mod b^{k+1}, r=r1−r2.
  If r<0, r=r+b^{k+1}.
  While r>=m do: r=r−m.  /* loop is repeated at most
  twice */
  Return(r).
```

Modified Barrett's Method 1: (for DSA Public Key Operations only)

Input: x=(x₄ₖ₋₁...x₁x₀)_{b}, m=(mₖ₋₁...m₁m₀)_{b}, b=2²⁵⁶, mₖ₋₁≠0.
Output: r=x mod m
u=└b^{4k}/m┘, q1=└x/b^{k-1}┘, q2=q1*u, q3=└q2/b^{3k+1}┘.
r1=x mod b^{k+1}, r2=q3*m mod b^{k+1}, r=r1−r2.
If r<0, r=r+b^{k+1}.
While r>=m do: r=r−m. /* loop is repeated at most
twice */
Return(r).

Modified Barrett's Method 2: (for RSA Public Key Operations only)

Input: x=(x₃ₖ₋₁...x₁x₀)_{b}, m=(mₖ₋₁...m₁m₀)_{b}, b=2²⁵⁶, mₖ₋₁≠0.
Output: r=x mod m
u=└b^{3k}/m┘, q1=└x/b^{k-1}┘, q2=q1*u, q3=└q2/b^{2k+1}┘.
r1=x mod b^{k+1}, r2=q3*m mod b^{k+1}, r=r1−r2.
If r<0, r=r+b^{k+1}.
While r>=m do: r=r−m. /* loop is repeated at most
twice */
Return(r).

2. Modular Addition

```
Input: A=(Aₖ₋₁...A₁A₀)_{b}, B=(Bₖ₋₁...B₁B₀)_{b}, N=(Nₖ₋₁...N₁N₀)_{b}, where
0≦A<N, 0≦B<N, b=2²⁵⁶.
Output: R=(Rₖ₋₁...R₁R₀)_{b}=(A+B) mod N
c=0
for i=0 to k−1 do:
  (c,R0ᵢ) = Aᵢ + Bᵢ + c  /* carry c stays in ALU */
c=1
for i=0 to k−1 do:
  (c,R1ᵢ) = R0ᵢ + ˜Nᵢ + c
if (c==0) R = R1 else R = R0;
Return(R).
```

3. Modular Subtraction

```
Input: A=(Aₖ₋₁...A₁A₀)_{b}, B=(Bₖ₋₁...B₁B₀)_{b}, N=(Nₖ₋₁...N₁N₀)_{b}, where
0≦A<N, 0≦B<N, b=2²⁵⁶.
Output: R=(Rₖ₋₁...R₁R₀)_{b}=(A−B) mod N
c=1
for i=0 to k−1 do:
  (c,R0ᵢ) = Aᵢ + ˜Bᵢ + c
if (c==0) R = R0.
otherwise(c≠0),
  let c=0, for i=0 to k−1 do:
    (c,R1ᵢ) = R0ᵢ + Nᵢ + c;
  R = R1;
Return(R).
```

4. Modular Inverse (N is Prime)

Input: A=(Aₖ₋₁...A₁A₀)_{b}, N=(Nₖ₋₁...N₁N₀)_{b}, b=2²⁵⁶.
Output: R=(Rₖ₋₁...R₁R₀)_{b}=A⁻¹ mod N.
E=N−2. /* N must be a prime */
R=A^{E} mod N. /* modular exponentiation */
Return(R).

5. Modular Inverse (Extended GCD/EEA)

```
Input: A=(Aₖ₋₁...A₁A₀)_{b}, N=(Nₖ₋₁...N₁N₀)_{b}, b=2²⁵⁶.
Output: R=(Rₖ₋₁...R₁R₀)_{b}=A⁻¹ mod N.
u1=1, u2=N, v1=0, v2=A  /* N can be even number */
while (v2 != 0) do:
  q=u2/v2;  /* use precision3 RCP calc */
  t1=u1−q*v1;
  t2=u2−q*v2;
  u1=v1;
  u2=v2;
  v1=t1;
  v2=t2;
d=u2; y=u1;  /* this step mainly for debug */
if (y<0) y=y+N;
R=y.
Return(R).
```

6. Modular Multiplication

```
Input: A=(Aₖ₋₁...A₁A₀)_{b}, B=(Bₖ₋₁...B₁B₀)_{b}, N=(Nₖ₋₁...N₁N₀)_{b}, where
0≦A<N, 0≦B<N, b=2²⁵⁶.
Output: R=(Rₖ₋₁...R₁R₀)_{b}=(A*B) mod N
u=└b^{2k+1}/N┘,
c=0
for i=0 to 2*k−1 do:
  Pᵢ = 0
for i=0 to k−1 do:
  for j=0 to i do:
    (Pᵢ₊₂Pᵢ₊₁Pᵢ) = (Pᵢ₊₂Pᵢ₊₁Pᵢ) + Aⱼ*Bᵢ₋ⱼ
for i=k to 2*k−2 do:
  for j=i−k+1 to k−1 do:  /* ignore P₂ₖ */
    (Pᵢ₊₂Pᵢ₊₁Pᵢ) = (Pᵢ₊₂Pᵢ₊₁Pᵢ) + Aⱼ*Bᵢ₋ⱼ
R=(P₂ₖ₋₁...P₁P₀)_{b} mod N  /* using pre-calculated u */
Return(R).
```

Reference: Standard Method

```
Input: A=(Aₖ₋₁...A₁A₀)_{b}, B=(Bₖ₋₁...B₁B₀)_{b}, N=(Nₖ₋₁...N₁N₀)_{b}, b=2²⁵⁶.
Output: R=(Rₖ₋₁...R₁R₀)_{b}=(A*B) mod N
for i=0 to 2*k−1 do:
  Pᵢ = 0
for i=0 to k−1 do:
  c=0
  for j=0 to k−1 do:
    (c,Pᵢ₊ⱼ) = Pᵢ₊ⱼ + Aⱼ*Bᵢ + c
  Pᵢ₊ₖ=c
R=(P₂ₖ₋₁...P₁P₀)_{b} mod N
Return(R).
```

Reference: A*B with A and B have different size

```
Input: A=(Aₘ₋₁...A₁A₀)_{b}, B=(Bₙ₋₁...B₁B₀)_{b}, b=2²⁵⁶.
Output: R=(Rₙ₊ₘ₋₁...R₁R₀)_{b}
c=0
for i=0 to n+m−1 do:
  Pᵢ = 0
for i=0 to n−1 do:
  for j=0 to min(i,m−1) do:
    (Pᵢ₊₂Pᵢ₊₁Pᵢ) = (Pᵢ₊₂Pᵢ₊₁Pᵢ) + Aⱼ*Bᵢ₋ⱼ
for i=n to n+m−2 do:
  for j=i−n+1 to min(i, m−1) do:
    (Pᵢ₊₂Pᵢ₊₁Pᵢ) = (Pᵢ₊₂Pᵢ₊₁Pᵢ) + Aⱼ*Bᵢ₋ⱼ
R=(Pₙ₊ₘ₋₁...P₁P₀)_{b}
Return(R).
```

7. Modular Squaring

```
-Input: A=(Aₖ₋₁...A₁A₀)_{b}, N=(Nₖ₋₁...N₁N₀)_{b}, b=2²⁵⁶.
-Output: R=(Rₖ₋₁...R₁R₀)_{b}=A² mod N
-u=└b^{2k+1}/N┘,
-c=0
-for i=0 to 2*k−1 do:
    Pᵢ = 0
-for i=0 to k−1 do:
    m=└i/2┘
    for j=0 to m do:
      s = i − j;
      if (j == s)
        (Pᵢ₊₂Pᵢ₊₁Pᵢ) = (Pᵢ₊₂Pᵢ₊₁Pᵢ) + Aⱼ*Aₛ ;
      else
        (Pᵢ₊₂Pᵢ₊₁Pᵢ) = (Pᵢ₊₂Pᵢ₊₁Pᵢ) + 2*Aⱼ*Aₛ ;
-for i=k to 2*k−2 do:
    m=└i/2┘
    for j=i−k+1 to m do: /* P₂ₖ = 0 */
      s = i − j;
      if (j == s)
        (Pᵢ₊₂Pᵢ₊₁Pᵢ) = (Pᵢ₊₂Pᵢ₊₁Pᵢ) + Aⱼ*Aₛ ;
      else
        (Pᵢ₊₂Pᵢ₊₁Pᵢ) = (Pᵢ₊₂Pᵢ₊₁Pᵢ) + 2*Aⱼ*Aₛ;
-R=(P₂ₖ₋₁...P₁P₀)_{b} mod N  /* using pre-calculated u */
-Return (R).
```

8. Modular Exponentiation (Square and Multiply Method)

```
-Input: A=(Aₖ₋₁...A₁A₀)_{b}, E=(eₖ₋₁...e₁e₀)₂, N=(Nₖ₋₁...N₁N₀)_{b}, b=2²⁵⁶,
        m=length(E) (in bits).
-Output: R=(Rₖ₋₁...R₁R₀)_{b}=A^{E} mod N
-u=└b^{2k+1}/N┘,
-R=A  /* eₘ₋₁=1 given m=length(E) */
-for i=m−2 down to 0 do:
    P = R*R  /* in RTL P = R * R′(image of R)
*/
```

| | |
|---|---|
| R = P mod N | /* using pre-calculated u */ |
| if (eᵢ==1) | |
| P = R*A | |
| R = P mod N | /* using pre-calculated u */ |
| -Return(R). | |

9. Double Modular Exponentiation (Square and Multiply Method)

```
-Input: A0=(A0ₖ₋₁...A0₁A0₀)_{b}, E0=(e0_{k*256-1}...e0₁e0₀)₂, N0=(N0ₖ₋₁
...N0₁N0₀)_{b},
      A1=(A1ₖ₋₁...A1₁A1₀)_{b}, E1=(e1_{k*256-1}...e1₁e1₀)₂, N1=(N1ₖ₋₁
...N1₁N1₀)_{b},
            b=2²⁵⁶.
-Output: R0=(R0ₖ₋₁...R0₁R0₀)_{b}=A0^{E0} mod N0
        R1=(R1ₖ₋₁...R1₁R1₀)_{b}=A1^{E1} mod N1
-u0=└b^{2k+1}/N0┘, u1=└b^{2k+1}/N1┘
/* locate the leading one in exponents E0 and E1 */
-i=k*256−1, j=k*256−1
-leading_one_found0=0, leading_one_found1=0
-while (i>0 && leading_one_found0==0 ||
      j>0 && leading_one_found1==0) do:
    if (e0ᵢ=1)
        leading_one_found0=1
    else if (leading_one_found0==0)
        i=i−1;
    if (e1ⱼ=1)
        leading_one_found1=1
    else if (leading_one_found1==0)
        j=j−1;
-m1=i; m2=j;
/* compute two modular multiplications in interleaving way
*/
/* mod′ is partial modular reduction without final
correction */
-i=m1−1; j=m2−1; do_sqr0=1; do_sqr1=1;
-R0=A0; R1=A1
-while (i>=0 && j>=0) do:
    if (do_sqr0==1) P0 = R0*R0; else P0 = R0*A0;
    if (do_sqr1==1) P1 = R1*R1; else P1 = R1*A1;
    R0 = P0 mod′ N0;  /* using u0 */
    R1 = P1 mod′ N1;  /* using u1 */
    if (do_sqr0==0 || e0ᵢ==0)
      {i=i−1; do_sqr0=1;}
    else
      do_sqr0=0;
    if (do_sqr1==0 || e1ⱼ==0)
      {j=j−1; do_sqr1=1;}
    else
      do_sqr1=0;
-while (i>=0) do:
    if (do_sqr0==1) P0 = R0*R0; else P0 = R0*A0;
    R0 = P0 mod′ N0;  /* using u0 */
    if (do_sqr0==0 || e0ᵢ==0)
      {i=i−1; do_sqr0=1;}
    else
      do_sqr0=0;
-while (j>=0) do:
    if (do_sqr1==1) P1 = R1*R1; else P1 = R1*A1;
    R1 = P1 mod′ N1;  /* using u1 */
    if (do_sqr1==0 || e1ⱼ==0)
      {j=j−1; do_sqr1=1;}
    else
      do_sqr1=0;
-While R0>=N0 do: R0=R0−N0. /* loop is repeated at most
twice */
-While R1>=N1 do: R1=R1−N1. /* loop is repeated at most
twice */
-Return(R0, R1).
```

10. DH Public Key Generation

-Input: N=(Nₖ₋₁...N₁N₀)_{b}, G=(Gₖ₋₁...G₁G₀)_{b}, X=(xₘ₋₁...x₁x₀)₂,
b=2²⁵⁶, m=length(X).
-Output: Y=(Yₖ₋₁...Y₁Y₀)_{b}= G^{x} mod N
-Y=(Yₖ₋₁...Y₁Y₀)_{b}= G^{x} mod N /* modular exponentiation */
-Return(Y).

11. DH Shared Secret Key Generation

-Input: N=(Nₖ₋₁...N₁N₀)_{b}, X=(xₘ₋₁...x₁x₀)₂, Y=(Yₖ₋₁...Y₁Y₀)_{b,}
b=2²⁵⁶, m=length(X).
-Output: R=(Rₖ₋₁...R₁R₀)_{b}= Y^{x} mod N
-R=(Rₖ₋₁...R₁R₀)_{b}= Y^{x} mod N /* modular exponentiation */
-Return(R).

12. RSA Encryption

-Input: N=(Nₖ₋₁...N₁N₀)_{b}, E=(eₘ₋₁...e₁e₀)₂, M=(Mₖ₋₁...M₁M₀)_{b},
b=2²⁵⁶, m=length(E).
-Output: C=(Cₖ₋₁...C₁C₀)_{b}= M^{E} mod N
-C=(Cₖ₋₁...C₁C₀)_{b}= M^{E} mod N /* modular exponentiation */
-Return(C).

13. RSA Decryption (CRT Algorithm)

```
-Input: P=(Pₖₚ₋₁...P₁P₀)_{b}, Q=(Q_{kq-1}...Q₁Q₀)_{b}, DP=(E0_{kP-1}...E0₁E0₀)_{b},
      DQ=(E1_{kq-1}...E1₁E1₀)_{b}, PINV=(PINV_{kq-1}...PINV₁PINV₀)_{b},
      C=(Cₖ₋₁...C₁C₀)_{b}, b=2²⁵⁶. (k=kp+kq)
-Output: M=(Mₖ₋₁...M₁M₀)_{b}
-/* following algorithm has been modified to support
different */
-/* P and Q size which difference is no larger than 256 */
-if (P_size != Q_size)
    UP1=└b^{3kp}/P┘, UQ1=└b^{3kq}/Q┘ /* Barrett Method3 */
-/* Get UP, UQ by right shifting UP1, UQ1 */
-UP=└b^{2kp+1}/P┘, UQ=└b^{2kq+1}/Q┘ /* Barrett Method1 */
-/* following two reductions are interleaved in hardware */
-/* mod′ is partial modular reduction without final
correction */
-XP=C mod P; XQ=C mod Q; /* use pre-calculated UP1 & UQ1
*/
              /* if P and Q size are different */
-YP=XP^{DP} mod P; YQ=XQ^{DQ} mod Q; /* use pre-calculated UP & UQ
*/
-/* following compute: M=(((YQ−YP)*PINV) mod Q)* P + YP */
```

| | |
|---|---|
| -YPMODQ=YP mod Q; | /* use pre-calculated UQ */ |
| -Y=YQ − YPMODQ mod Q; | /* use pre-calculated UQ */ |
| -X=Y * PINV mod Q; | /* use pre-calculated UQ */ |
| -M1=X * P | |
| -M=M1 + YP | |
| -Return(M). | |

14. DSA Sign

```
-Input: Q=(Q₀)_{b}, P=(Pₖ₋₁...P₁P₀)_{b}, G=(Gₖ₋₁...G₁G₀)_{b}, X=(x₁₅₉...x₁x₀)₂,
        H=(H₀)_{b}, K=(k₁₅₉...k₁k₀)₂, b=2²⁵⁶.
Output: R=(R₀)_{b}=(G^{K} mod P) mod Q
          S=(S₀)_{b}=(K⁻¹ *(H+X*R)) mod Q
/* UP use Barrett Method1, UQ use Barrett Method2 */
-UP=└b^{2k+1}/P┘, UQ=└b⁴/Q┘.
/* modular reduction is done since H or K maybe greater
than Q because of random generation */
-HMODQ=H mod Q; KMODQ=K mod Q; /* using MSUB */
/* locate the leading one in exponent K required by above
/* modular exponent algorithm
-leading_one_found=0; i=159;
-while (i>0 && leading_one_found==0) do:
    if (KMODQᵢ==1)
      leading_one_found=1;
    else
      i=i−1;
```

| | |
|---|---|
| -Y=G^{KMODQ} mod P; | /* using pre-calculated UP */ |

| | |
|---|---|
| -R=Y mod Q; | /* using pre-calculated UQ */ |
| -KINV=KMODQ^{Q-2} mod Q; | /* using pre-calculated UQ */ |

| | |
|---|---|
| -Z=X * R mod Q | /* using pre-calculated UQ */ |
| -Y=HMODQ + Z mod Q | /* using pre-calculated UQ */ |

| | |
|---|---|
| -S=KINV * Y mod Q | /* using pre-calculated UQ */ |
| -Return(R,S). | |

15. DSA Verify

-Input: Q=(Q₀)_{b}, P=(Pₖ₋₁...P₁P₀)_{b}, G=(Gₖ₋₁...G₁G₀)_{b}, Y=(Yₖ₋₁...Y₁Y₀)_{b},
H=(H₀)_{b}, R=(R₀)_{b}, S=(S₀)_{b}, b=2²⁵⁶.
-Output: V=(V₀)_{b}=((G^{U1} * Y^{U2}) mod P) mod Q
/* UP use Barrett Method1, UQ use Barrett Method2 */
-UP=└b^{2k+1}/P┘, UQ=└b⁴/Q┘.
/* modular reduction is done since H maybe greater */
/* than Q */

| | |
|---|---|
| -HMODQ=H mod Q; | /* using MSUB */ |

| | |
|---|---|
| -W=S^{Q-2} mod Q; | /* using pre-calculated UQ */ |

| | |
|---|---|
| -U1=HMODQ * W mod Q; | /* using pre-calculated UQ */ |
| -U2=R * W mod Q; | /* using pre-calculated UQ */ |

-T1=G^{U1} mod P; T2=Y^{U2} mod P;/* dbl exponentiation */

| | /* using pre-calculated UP */ |
|---|---|
| -Z=T1 * T2 mod P | /* using pre-calculated UP */ |
| -V=Z mod Q | /* using pre-calculated UQ */ |
| -Return(V). | |

In one embodiment, the present invention utilizes a modified Barrett algorithm to perform modular reduction. The system of the present invention therefore needs to calculate u=└b^{2k+1}/N┘ so that it can perform A mod N, where N is up to 4096-bit modulus, A is at most twice the size of N plus 4 bits, and b=2²⁵⁶. Because of A and N size ratio limitation, we devise another two modified Barrett algorithm to support different A and N size ratios required in some DSA and RSA operations.

Actually, in some DSA operations, different p, q size RSA Chinese Remainder Theory (CRT) operations and division (needed by Extended Greatest Common Divisor (GCD)), different precision u is needed. In one embodiment, the invention supports 4 different precision u calculations. Precision 0 is for u=└b^{2k+1}/N┘, Precision 1 is for u=└b^{4k}/N┘, Precision 2 is for u=└b^{3k}/N┘, and Precision 3 is u=└b^{k+2}/N┘ (only for this precision, the condition Nₖ₋₁≠0 is not needed).

In one embodiment, all long integers are divided into multiples of 256 bits to participate in arithmetic operations because 256-bit is the operand size of one embodiment of the arithmetic core unit.

Following definitions will be used throughout this document:
b - - - high radix (data width), b=2²⁵⁶
N - - - modulus before normalization N=(Nₖ₋₁Nₖ₋₂ . . . N₀)_{b}, Nₖ₋₁≠0
d - - - modulus after normalization
n - - - length of modulus N in bits (16≦n≦4096)
k - - - number of bits in radix b for N=(Nₖ₋₁Nₖ₋₂ . . . N₀)_{b} where Nₖ₋₁≠0, k=┌n/256┐
K - - - length of modulus N in bits that ceiled to next 256-bit boundary, K=k*256
   Exception: K=512 when k=1.
p - - - precision (in bits) required for i+1ₜₕ Newton iteration.
s - - - normalized shifting count

In one embodiment, the present invention modifies the Newton Raphson reciprocal iteration algorithm for a better performance. The Newton Raphson reciprocal algorithm is modified to include truncations and use 1's complements (instead of 2's complements), as illustrated below.

The basic Newton Raphson method is performed using the following equation:
R[i+1]=R[i](2−dR[i])/* R[0]=initial approximation of 1/d ε[i+1]=ε[i]²/*ε[i]=(1/d−1/R[i])/(1/d)=1−dR[i]

However, the above basic Newton Raphson method is modified for a more efficient hardware implementation.

Y[i] = dR[i] /* R[0] = initial approximation of 1/d,
1≦d<2 */
Z[i] = 2 − Y[i] − ulp /* use 1's complement
instead of 2's */

/* ulp = 2^{-(K+m)} where */

```
  /* m is len of R[i] in bits excluding 1 integral bit */
  /* K is len of d in bits excluding 1 integral bit */
R[i+1] = R[i]Z[i] − 2^{-p}R_{f}[i+1] /* truncate R[i]Z[i] to p+1 bit
b₀.b₁b₂b₃...bₚ */
```

/* p is precision we need for i+1ₜₕ iteration */

/* 0≦R_{f}[i+1]<1 */

ε[i+1] = ε[i]² + ulp(1 − ε[i]) + 2^{-p} dR_{f}[i+1]

| | |
|---|---|
| < 2ε[i]² | /* we make sure ulp(1 − ε[i]) + 2^{-p}dR_{f}[i+1] < |
| ε[i]² */ | |

As shown above, the modified Newton Raphson method performs possible truncation on dR[i], uses 1's complement instead of 2's complement in 2−Y[i], and truncates R[i]Z[i] thus, R[i] size varies per iteration. As a result, more aggressive truncations can be done in early iterations.

The following Table 1 shows precision errors based on different number of iterations. Depending on operation type and size of the key, different error tolerance (precision) may be chosen from the table, which in turn, gives the number of required iterations.

TABLE 1
Relative Error Table under Modified Newton Raphson
method:

ε[0] < 2⁻⁹ , /* initial approximation */
ε[1] < 2⁻¹⁷ ,
ε[2] < 2⁻³³ ,
ε[3] < 2⁻⁶⁵ ,
ε[4] < 2⁻¹²⁹ ,
ε[5] < 2⁻²⁵⁷ ,
ε[6] < 2⁻⁵¹³ ,
ε[7] < 2⁻¹⁰²⁵ ,
ε[8] < 2⁻²⁰⁴⁹ ,
ε[9] < 2⁻⁴⁰⁹⁷ ,
ε[10] < 2⁻⁸¹⁹³

In one embodiment, a special purpose hardware performs the modified Newton Raphson method as follow:

Input:

Integer k, precision type Precision, n-bit integer N=(Nₖ₋₁ Nₖ₋₂ . . . N₀)_{b} where 16≦n≦4096 or higher, b=2²⁵⁶, Nₖ₋₁≠0 (except Precision=3). Leading bits of N could be 0 before normalization.

Output:

If Precision=0, return (k+2)*256-bit reciprocal R=└b^{2k+1}/N┘=└2^{(2k+1)*256}/N┘;

If Precision=1, return (3k+1)*256-bit reciprocal R=└b^{4k}/N┘=└2^{4k*256}/N┘;

If Precision=2, return (2k+1)*256-bit reciprocal R=└b^{3k}/N┘=└2^{3k*256}/N┘;

If Precision=3, return (s1+3)*256-bit reciprocal R=└b^{k+2}/N┘=└2^{(k+2)*256}/N┘;

Method:

i) Normalize N into d so that N=d*2^{-s}*2^{K}, 1≦d<2 (d=1.b₁b₂b₃ . . . b_{K}), s=k*256−n+1, calc s1=(s−1)/256. If k=1, pad zeros at the end of d to make sure d has at least 512-bit fraction (K≧512).
ii) Use Midpoint Reciprocal Table (9-bits-in, 8-bits-out) or Bipartite Reciprocal Table to obtain initial approximation of 1/d R[0] with 9 bit precision, that's, ε[0]<2⁻⁹.
Determine the number of iterations T. In one embodiment, the number of iterations T is determined by a Relative Error Table.

Determine the required precision P_{final} of reciprocal └2^{(2k+1)*256}/N┘(in bits), where p_{final}=(2k+1)*256−n+1 includes the significant bits in the reciprocal. It can be proven that └2^{(2k+1)*256}/N┘<2^{(k+2)*256}. Thus, p_{final}=(k+2)*256=K+512 is chosen

```
    if (k>1)
    K=256*k;
        else
      K=512;
      Switch (Precison)
      {
  case 0 :  p_{final}=(k+2)*256; kk = k; break;
  case 1 :  p_{final}=(3*k+1)*256; kk = 3*k − 1; break;
  case 2 :  p_{final}=(2*k+1)*256; kk = 2*k − 1; break;
  case 3 :  p_{final}=(S1+3)*256; kk = s1 + 1; break;
}
Switch (kk)
{
    case 1, 2:  /* 16-512 bit modulus, p_{final}=768 or 1024 */
            T = 7;  break;  /* ε[7]  <  2⁻¹⁰²⁵ */
  case  3..6:  /* 513-1536 bit modulus
P_{final}=1280,1536,1792,2048 */
        T = 8;  break;  /* ε[8]  <  2⁻²⁰⁴⁹ */
      case 7..14:  /* 1537-3584 bit modulus,
P_{final}=2304,2560,2816,  */
          /* 3072, 3328,3584,3840,4096
    */
            T = 9;  break;  /* ε[9]  <  2⁻⁴⁰⁹⁷ */
    case  15, 16:  /* 3585-4096 bit modulus,
P_{final}=4352,4608  */
            T = 10;  break;  /* ε[10]  <  2⁻⁸¹⁹³ */
    default:  /* set default to k=1 */
            T =  7; break;
}
```

iii) Refine reciprocal approximation by Newton iterations.

```
  for (i=0; i<5; i++)  /* keep R[0-4] as 256+1 bit, R[5] as
512+1 bit */
{  /* d=1.b₁b₂b₃...b_{K}, R[0-4]=r₀.r₁r₂r₃...r₂₅₆, R[5] =r₀. r₁r₂r₃... r₅₁₂ */
    if (i=4) p=512 else p=256
    Y[i] = dR[i] − 2^{-K}Y_{f}[i];  /* truncate to K+1 bits,
0≦Y_{f}[i]<1 */
    Z[i] = 2 − Y[i] − 2^{-k};  /* ulp = 2^{-k}*/
    R[i+1] = R[i]Z[i] − 2^{-p}R_{f}[i+1];  /* 0≦R_{f}[i+1]<1 */
    ε[i+1] = ε[i]² + 2^{-K}(1 − ε[i]) (1 − Y_{f}[i]) + 2^{-p}dR_{f}[i+1] ;
    /* ε[i+1] <ε[i]² + ε[i]²=2ε[i]² because K≧512 and p=256 or 512
*/
}
*/ we obtain at least 256 bit precision or ε[5]  <  2⁻²⁵⁷ after
5^{th} iteration */
for (i=5; i<T; i++) /* keep R[i] as m+1 bit */
{ /* d=1.b₁b₂b₃...b_{K}, R[i] =r₀.r₁r₂r₃...rₘ */
  m=256 + 256*2ⁱ⁻⁵;
    p=m+256*2ⁱ⁻⁵;
  Y[i] = dR[i];  /* drop MSB integral bit */
    Z[i] = 2 − Y[i] − 2^{-(k+m)};  /* ulp = 2^{-(K+m-1)} */
    R[i+1]= R[i]Z[i] − 2^{-p}R_{f}[i+1];  /* truncate to p+1
bit*/
    ε[i+1] = ε[i]² + 2^{-(K+m)}(1 − ε[i]) + 2^{-p}dR_{f}[i+1] ;
    /* ε[i+1] <2ε[i]² [i<T−1) or ε[i+1] < 2^{-pfinal} (i=T−1) */
    /* because 2^{-(K+m)} (1 − ε[i]) + 2^{-p}dR_{f}[i+1] <ε[i]² for all i<T−1
*/
}
if (i==T)  /* when i=T−1, p > p_{final} before adjustment */
            /* truncate more to p_{final} bits */
    R[T] = R[T] * 2^{P} >> (p − p_{final})
```

iv) Denormalize R[T] so that R=└2^{(2k+1)*256}/N┘=r₁r₂r₃. . . r_{K+512}=(R[T]<<s)>>256.
v) Output (k+2)*256 bit reciprocal R

In short, in an embodiment of the present invention, a typical modular operation according to a modified Barrett algorithm can be summarized as follow: (exponentiation R=A^{E} is used as an example here):
Step 0: Calculate reciprocal u=└b^{2k+1}/N┘ using the devised modified Newton Raphson method
Step 1: multiplication or addition (In this example, X=R*R or X=A*R depending on current exponent bit is 1 or 0, initial R=A)
Step 2=partial Barrett reduction per our modified Barrett algorithm
   q1=└X/b^{k-1}┘
   q2=q1*u
   q3=└q2/b^{k+2}┘
   r1=X mod b^{k+1}
   r2=q3*N mod b^{k+1}
   R=r1−r2
Step 3: loop step 1 and 2, if loop not done;
   Otherwise, go to step 4
Step 4=Final Correction:
   while R>=N, do:R=R−N (modular operation)

A reciprocal algorithm according to modified Newton Raphson method is summarized as follow:
Step 0: input operand to be calculated (modulus N);
Step 1: Normalize N to get d;
Step 2: Use Lookup table to get rcpl seed R0 (repl-tbl)
Step 3: Determine iteration number (ctl−rcpl) using Relative
   Error Table and size of N, precision type(0-3)
Step 4: reciprocal main portions in each iteration
   Y=d*R
   Z=1's complement of Y
   R=Z*R
Step 5: Denormalize R (left shift R by S bit)
Step 6: output reciprocal R of N
   R=└b^{m}/N┘, m=2k+1, 3k+1, . . .

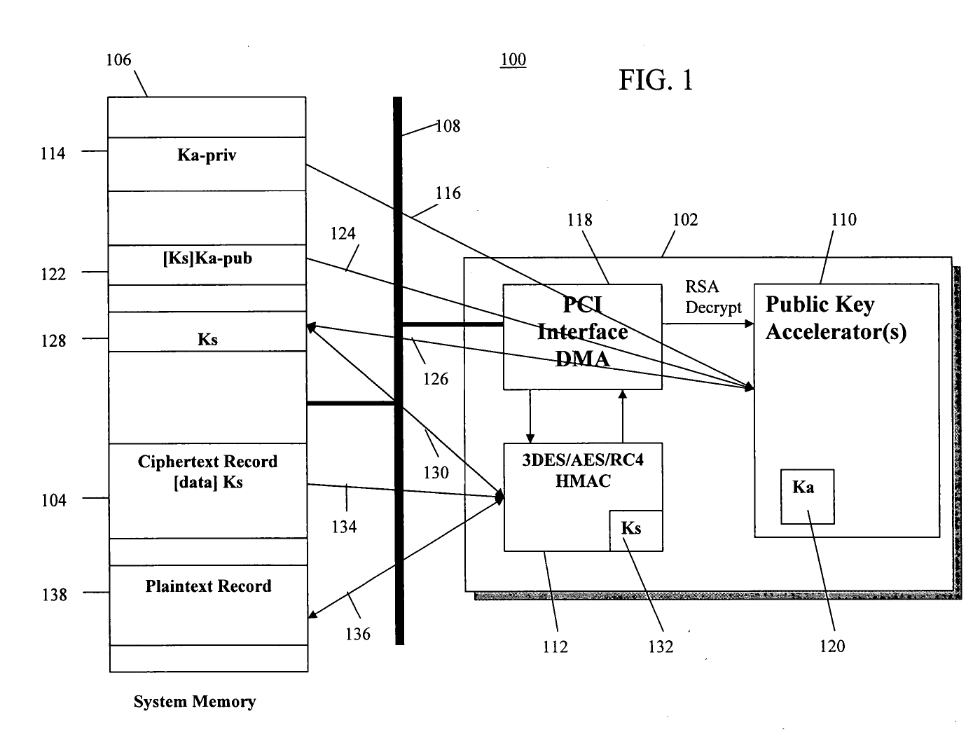

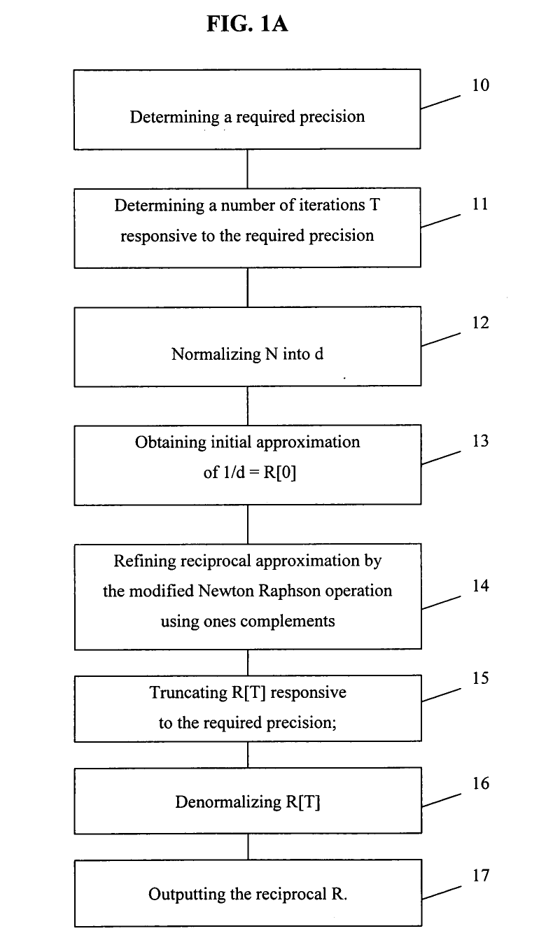

FIG. 1A is an exemplary process flow diagram for calculating a reciprocal R of an integer N, according to one embodiment of the present invention. In block 10, a required precision for the modified Newton Raphson operation is determined. According to the above example, a 1× precision is for normal division which is used in Extended Euclid GCD modular inverse algorithm in a public key system, a 2× precision is for most public key operations, a 3× precision is for RSA CRT operations, and a 4× precision is for DSA operations.

In block 11, the number of iterations T for the modified Newton Raphson operation is determined responsive to the required precision. In block 12, N is normalized into d so that N=d*2^{-s}*2^{K}, 1≦d<2 (d=1.b₁b₂b₃ . . . b_{K}) , where N=(Nₖ₋₁Nₖ₋₂ . . . N₀)_{b} is modulus before normalization, d is the intermediate results after normalization, and s is the normalize shift count.

In block 13, the initial approximation of 1/d=R[0] is obtained, where R is reciprocal at different iterations of a modified Newton Raphson operation. In block 14, the reciprocal approximation is refined by the modified Newton Raphson operation using ones complements, instead of two's complements. In block 14, all intermediate results are also truncated responsive to the required precision after each iteration according to the modified Newton Raphson method. In block 15, the final iteration result R[T] is truncated responsive to the required precision. In block 16, R[T] is denormalized and the reciprocal R is outputted in block 17.

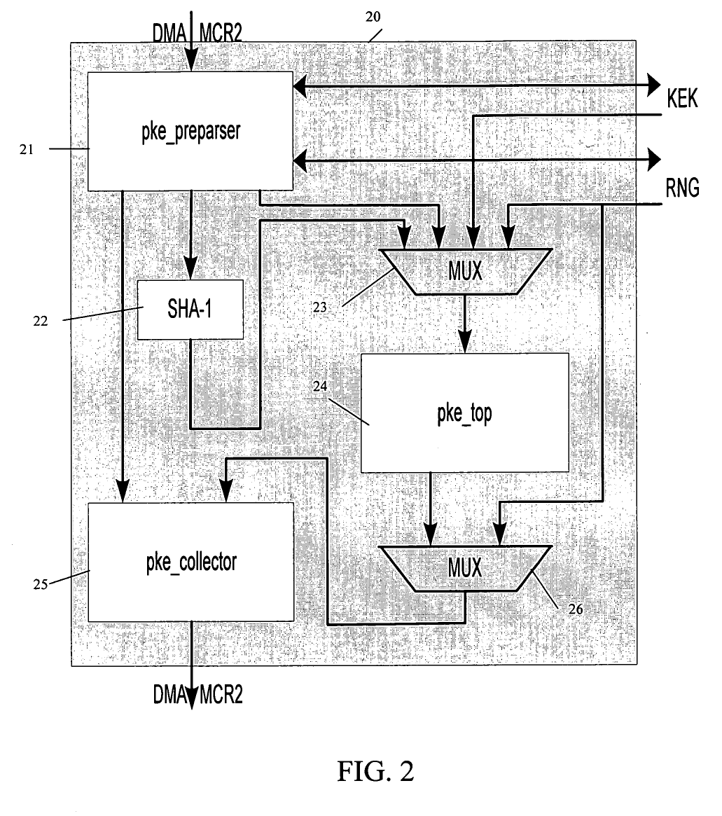

FIG. 2 is an exemplary block diagram of a PKE, according to one embodiment of the present invention. As shown, a preparser block 21 receives MCR2 packet from DMA and parses the packet to determine type of encryption operation, size of the key, data payload and the like. The general information of input packet like packet header, operation type, size, etc., as output of the preparser 21 is fed to a pke_collector 25 to control the result collection in the last stage. The output of the preparser 21 is also fed to a SHA-1 engine 22 to perform the hashing operation on unhashed messages required in DSA operation. The output of the preparser 21 is also fed to a multiplexor 23. The multiplexor 23 inputs also include plain keys from key encryption key (KEK) engine, a random number generated by a random number generator(RNG), and the output of the SHA-1 engine 22.

The multiplexor 23 selects one of its inputs based on operation type and its option parameters to feed to a PKE core 24. The PKE core performs the modular arithmetic based on modified Barrett algorithms. The output of the PKE core 24 and the random number are fed to a second multiplexor 26. The second multiplexor 26 select either the random number (if the operation type is RNG opcode) or the output of the PKE core 24 (if operation type is PKE opcode) and feeds it to the pke_collector 25. The pke_collector 25 packs the final result in a packet in a predefined format.

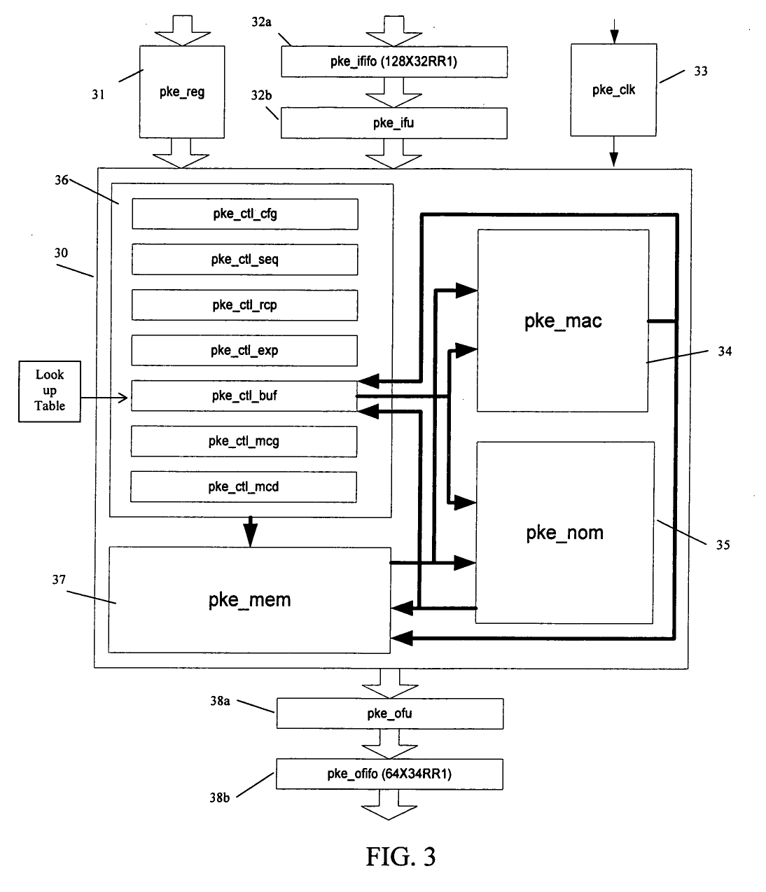

FIG. 3 is an exemplary block diagram of a PKE core, according to one embodiment of the present invention. As shown, the data payload is input to a FIFO 32a and then to a input parser 32b. A register block 31 provide some control registers used by PKE core. The clock to the PKE core 30 is generated by a clock gating circuit 33 for power saving purpose. A controller 36 includes several control blocks 36ato 36g. Configuration control block 36a stores parameters and status for current PKE operation. Reciprocal block (module) 36c generates some control information for reciprocal iterations like number of iteration, dropping count for each iteration, etc. Exponential block (module) 36d scans the exponent bits and provide information to control exponention iteration loop. A scratch pad buffer 36e is connected to a reciprocal seed look up table 39, the memory and output of arithmetic/shifting units. The data in scratch pad buffer 36e can be fed directly to arithmetic/shifting units without memory access laterncy. The scratch pad buffer 36e is also used to facilitate constant operands, copy operations.

Sequencer block 36b handles the top level operation sequencing. A microcode generation block (module) 36f generate micro code on the fly, as described in more detail below. A microcode decoder 36g decodes the generated microcode for the arithmetic operation of MAC 34 and shifting logic NOM 35. MAC 34 is a high performance pipelined multiplication and accumulation unit which supports operand sizes of 256 plus 4 bits. The Reciprocal block 36c, Exponential block 36d, scratch pad buffer 36e, MAC 34 and shifting logic 35 are collectively referred to as execution module.

A memory 37 stores the payload and data. In one embodiment, memory 37 is a dual port memory (e.g., a RAM) that includes a unique memory structure and address mapping to support up to three Read and one Write operations simultaneously. Output parser 38a and output FIFO 38b are used to output the result of the PKE core operations.

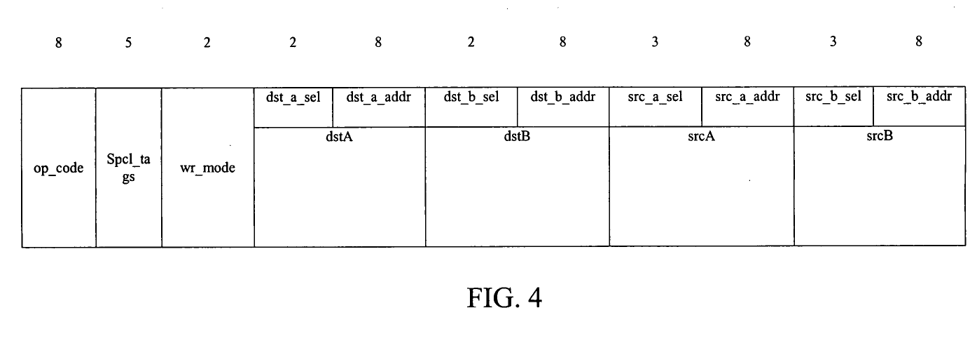

FIG. 4 is an exemplary microcode instruction format, according to one embodiment of the present invention. The number of bits assigned to each microcode field is for illustration purposes. Those skilled in the art would recognize that other bit lengths for different fields of the microcode are within the scope of the invention. The exemplary fields including some op_codes with different arithmetic operations on different operands are illustrated below. Particularly, NOM and DNOM op_codes are used for shifting operations performed in normalizer(PKE_NOM).

op_code (8 bits):
Pri-code (4bits)

| h0 : | NOP | |
|---|---|---|
| h1 : | COPY (R→W) | |
| h2 : | LOAD (R→W) | |
| h3 : | NOM | |
| | (R→L→S0→S1→S2→S3→S4→S5→S6→S7→W0→W1→S8/ | |
| | W) | |
| h4 : | DNOM | |
| | (R→L→S0→S1→S2→S3→S4→S5→S6→S7→W0→W1→S8/ | |
| | W) | |
| h5 : | ADD | two paths: (R→A0→A1→A2→W) or |
| | | (R→M0→M1→M2→M3→C→A0→A1→A2→W) |
| h6 : | SUB | two paths: (R→A0→A1→A2→W) or |
| | | (R→M0→M1→M2→M3→C→A0→A1→A2→W) |
| h7 : | MUL | (R→M0→M1→M2→M3→C→A0→A1→A2→W) |
| h8 : | MAC | (R→M0→M1→M2→M3→C→A0→A1→A2→W) |

| | |
|---|---|
| h9-F : | reserved |

Where, R is a Read operation, W is a Write operation, S is a shift operation, L is a Load operation, Wₓ is a Wait operation, A is an Add operation, C is a carry-save 3-2 addition, and M is a Multiplication operation.

Sub-code(4 bits): subtypes for a specific primary operation (see below)
2. Spcl_tags(5 bits): special tags needs for certain operations like conditional drop, etc.
   [0]: last instruction of current long integer operation microcode sequence. Used for setting status flags.
   [1]: drop on previous MAC flags neg_flag set
   [2]: drop on previous MAC flags neg_flag not set
   [3]: drop on ctlbuf0_sign not set (R0=0)
   [4]: inverse all the result bits [256:0], [260:257] are cleared

3. wr_mode(2 bits): only applies to destination write from pke_mac/pke_nom

| | |
|---|---|
| 00: | dst[260:0] ← R[1260:0] write all 261 bits |
| | (default) |
| 01: | dst[260:0] ← {5′b0, R[255:0]} |
| 10: | dst[260:0] ← {1′b0, R[3:0], dst[255:0]} |
| 11: | dst[260:0] ← {1′b0, R[259:0]} clear sign bit |
| | [260]. |

4. dst_sel(2 bits)/src_sel(3 bits):

dst_sel :

| | |
|---|---|
| 00 | ram |
| 01 | buffer registers |
| 10 | reserved |
| 11 | no dst |

src_sel :

| | |
|---|---|
| 000 | ram |
| 001 | buffer registers |
| 010 | ALU feedback |
| 011 | immediate value (0 ˜ 255) |
| 100 | no src |
| 101-111 | reserved |

Note:
for normalization instructions, srcB is always used to store dstA base address.

5. addr(8 bits):
   Specify ram or control/buffer register address. Current RAM size is 4×64×261 bit. For control registers, currently we have 2 working parameter registers and 4 working buffer registers(R0, R1, R2 and R3).
   Ram address format:
   [7:6] ram_sel (RAM0˜RAM3)
   [5:0] row_sel (ROW0˜ROW63)
   Note: all columns (COL0-COL7) are selected because of 256 bit word size.

An exemplary microcode instruction set, according to one embodiment of the present invention, is described below.
1) NOP No operation (1 cycle)
2) COPY R←A (2 cycles), optionally R0←A
   A is in RAM, R can be in RAM or ctl_bufs. Optionally A can also be copied to ctlbuf0(R0) as long as A is not R0. No memory write when using this instruction.
3) LOAD R←ctl_buf0(R0)/immediate value (2 cycles)
   R is in RAM, immediate value is written through ctl_buf0(R0).
4) NOM NOM1/NOM2/NOMF

NOM1: clear normalizer internal states and counters; do leading one detection. It's used as first normalization instruction.

NOM2: update normalizer states and counters; do normalization. It's used for second to last input data.

NOMF: flush out the last result data in normalizer. It's always used as last normalization instruction.

Note: Rules on result generation:
1) if status tag ld-one_found is false after a normalization, zero is written as result to dst_base+(ld₋zero_cnt−1).
2) if both status tags ld_one_found and first_nz_dat are true, no result is generated, Partial result resides in normalizer and need to be merged with next input data.
3) if ld_one_found is true but first_nz_dat is false, one result is
   written to dst_addr+ld_zero_cnt
4) always write a result to dst_addr+ld_zero_cnt after NOMF instruction.
5) DNOM DNOM1/DNOM2

DNOM1: initialize normalizer internal states for denormalization. One result is generated.

DNOM2: Denormalization shifting and merging. Result generated.

6) ADD ADD0/ADDC/ADD0L/ADDCL/ADD1L

| | |
|---|---|
| ADD0: | R [symbol] A + B (short pipeline path) |
| ADDC: | R [symbol] A + B + c (internal carry) (short |
| | pipeline path) |
| ADD0L: | R [symbol] A + B (long pipeline path) |
| ADDCL: | R [symbol] A + B + c (internal carry) (long pipeline |
| | path) |
| ADD1L: | R [symbol] ALU_C[260:0] + ALU_S[260:0] + c |
| | (internal carry) |

7) SUB SUB0/SUBC/SUB0L/SUBCL

| | |
|---|---|
| SUB0: | R [symbol] A − B = A + ˜B + 1 (short pipeline |
| | path) |
| SUBC: | R [symbol] A + ˜B + c (internal carry) (short |
| | pipeline path) |
| SUB0L: | R [symbol] A − B = A + ˜B + 1 (long pipeline |
| | path) |
| SUBCL: | R [symbol] A + ˜B + c (internal carry) (long pipeline |
| | path) |

8) MUL MUL0/MUL1/MUL2

| | |
|---|---|
| MUL0: | (CSA_C, CSA_S) [symbol] A * B |
| | (ALU_C, ALU_S) [symbol] (CSA_C, CSA_S) >> 256 |
| | R [symbol] CSA_C[255:0] + CSA_S[255:0] |
| MUL1: | (CSA_C, CSA_S) [symbol] A * B |
| | (ALU_C, ALU_S) [symbol] (CSA_C, CSA_S) >> 256 |
| | R [symbol] CSA_C[260:0] + CSA_S[260:0] |

9) MAC MAC0/MAC1/MAC2/MAC3/MAC4

| | |
|---|---|
| MAC0: | (CSA_C, CSA_S) [symbol] (CSA_C, CSA_S) >> 256 + A * B |
| | (ALU_C, ALU_S) [symbol] (CSA_C, CSA_S) >> 256 |
| | R [symbol] CSA_C[255:0] + CSA_S[255:0] + c (internal |
| | carry) |
| MAC1: | (CSA_C, CSA_S) [symbol] (CSA_C, CSA_S) + A * B |
| | (ALU_C, ALU_S) [symbol] (CSA_C, CSA_S) >> 256 |
| | R [symbol] CSA_C[255:0] + CSA_S[255:0] + c (internal |
| | carry) |
| MAC2: | (CSA_C, CSA_S) [symbol] (CSA_C, CSA_S) >> 256 + 2 * A * |
| | B (ALU_C, ALU_S) [symbol] (CSA_C, CSA_S) >> 256 |
| | R [symbol] CSA_C[255:0] + CSA_S[255:0] + c (internal |
| | carry) |
| MAC3: | (CSA_C, CSA_S) [symbol] (CSA_C, CSA_S) + 2 * A * B |
| | (ALU_C, ALU_S) [symbol] (CSA_C, CSA_S) >> 256 |
| | R [symbol] CSA_C[255:0] + CSA_S[255:0] + c (internal |
| | carry) |
| MAC4: | (CSA_C, CSA_S) [symbol] (CSA_C, CSA_S) >> 256 + A * B |
| | (ALU_C, ALU_S) [symbol] (CSA_C, CSA_S) >> 256 |
| | R [symbol] CSA_C[260:0] + CSA_S[260:0] + c (internal |
| | carry) |
| MAC8: | (CSA_C, CSA_S) [symbol] (CSA_C, CSA_S) >> 256 + A * B |
| | (ALU_C, ALU_S) [symbol] (CSA_C, CSA_S) >> 256 |
| | No add |
| MAC9: | (CSA_C, CSA_S) [symbol] (CSA_C, CSA_S) + A * B |
| | (ALU_C, ALU_S) [symbol] (CSA_C, CSA_S) >> 256 |
| | No add |
| MAC10: | (CSA_C, CSA_S) [symbol] (CSA_C, CSA_S) >> 256 + 2 * A * |
| | B (ALU_C, ALU_S) [symbol] (CSA_C, CSA_S) >> 256 |
| | No add |
| MAC11: | (CSA_C, CSA_S) [symbol] (CSA_C, CSA_S) + 2 * A * B |
| | (ALU_C, ALU_S) [symbol] (CSA_C, CSA_S) >> 256 |
| | No add |

The above microcode instructions are generated on the fly and immediately executed by the PKE core to perform the desired operation. The microcode instruction architecture is designed for efficient generic long integer arithmetic operations.

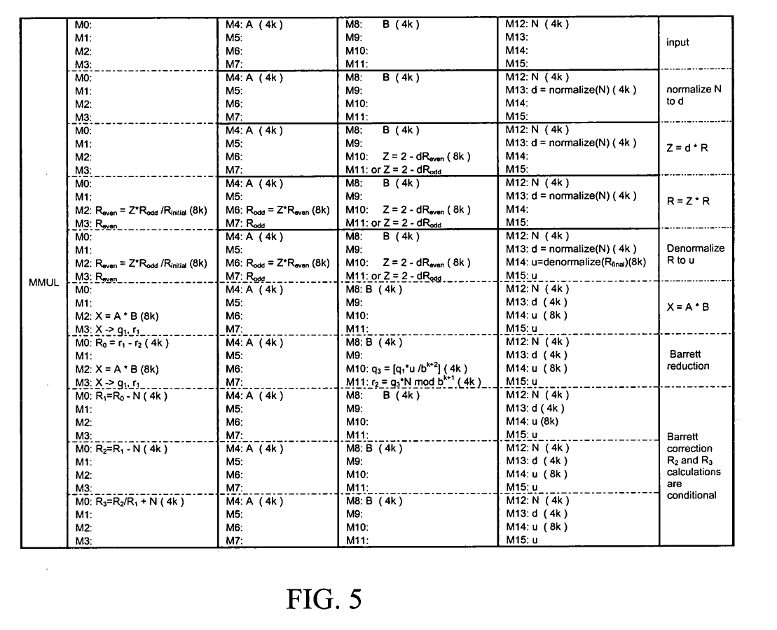

FIG. 5 is an exemplary block diagram depicting the memory structure for a modular multiplication operation of R=A*B mod M (b=2²⁵⁶, k=2), according to one embodiment of the present invention. As shown, the dual port memory 40 is divided into four banks. For example, the first bank 41 is configured for the result of an operation, the second bank 42 is configured for a first operand, the third bank 43 for a second operand and the fourth bank 44 for a third operand. Memory locations are pre-allocated for all input, output, and intermediate results to avoid memory contention.

Stage 0 is a memory snapshot after input. Stage 1 is to normalize modulus N to d which is assigned to location M13. Stage 2 is to compute Z=d*R. New memory locations M9 to M11 are allocated for Z, locations M2 to M3 are allocated for R (for 0^{th}, 2^{nd}, 4^{th}, iterations) and locations M6 to M7 are allocated for R (for 1^{st}, 3^{rd}, 5^{th}, . . . iterations). Stage 3 is to compute R=Z*R. We can see from this stage how M6 to M7 and M2 to M3 are interleavely used for storing R. Stage 2 and Stage 3 are looped until R satisfies the precision requirement. Stage 4 is to shift R to obtain final reciprocal U which is assigned to location M14 to M15. Stage 5 is to compute product of A and B (X=A*B). The product X is allocated at locations M2 to M3 (overwrite R in stage 2 & 3). Stage 6 is to perform partial Barrett Reduction. New locations are allocated for q3 and r2. q1 and r1 each is actually portion of X. Locations M0 is allocated for intermediate result R. Stage 7 to Stage 9 are to perform Barrett correction (R=R−N while R>N). Final result is at location M0. For modular multiplications, two memory reads (portion of A and B) and one write (portion of R) is needed at the same time. However, for modular exponentiation, at the same time that two operands (A and B) are read from memory, additional memory read may be needed for exponent (E), if the current exponent window scanning comes to the end. The memory structure design efficiently use standard dual port (one read one write) memory to build a larger memory that supports three reads and one write.

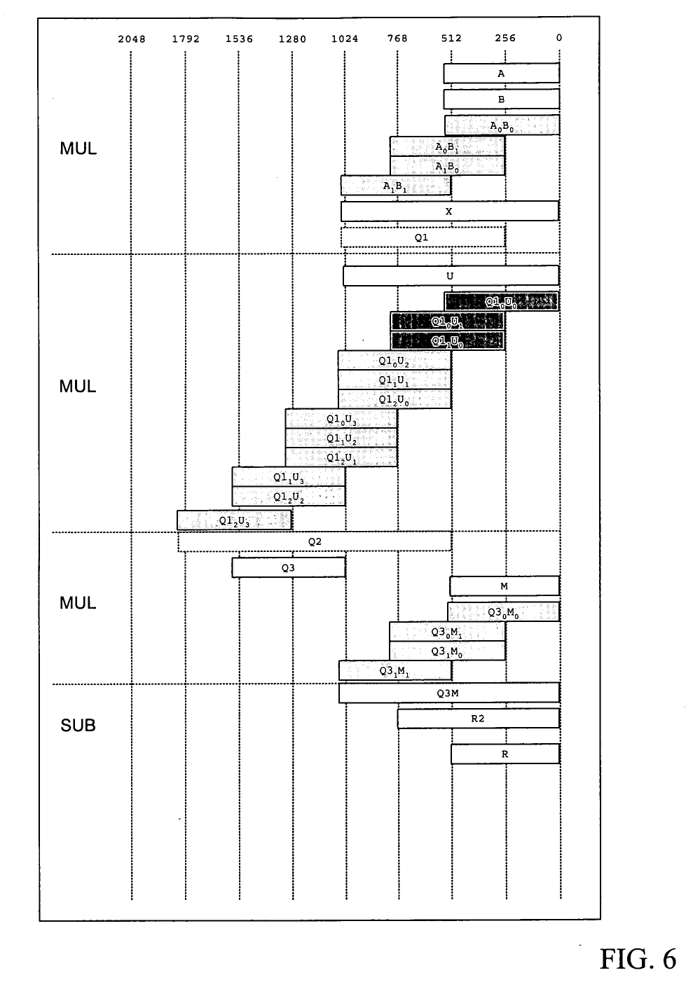

FIG. 6 is an exemplary process flow for a modular multiplication operation of R=A*B mod M (b=2²⁵⁶, k=2).

Stage 1(MUL): Shows how a 512 bit multiplication A*B (Stage 5 of FIG. 5) is divided into 4 smaller 256 bit multiplications that can be performed in our hardware execution unit. Stage 2 to Stage 4 show how a Barrett reduction (Stage 6 of FIG. 5) is done and optimized. In this example, U=└b^{2k+1}/M┘ is precomputed from Stage 1 to Stage 4 of FIG. 5

Stage 2(MUL): Computations done in this stage are Q1=└X/b^{k-1}┘ (part of X, no shifting needed), Q2=Q1*U, Q3=└Q2/b^{k+2}┘ (part of Q2, no shifting needed). The main operation is a 768 bit*1024 bit multiplication (Q1*U) which is divided into 12 smaller 256 bit multiplication. The first 3 multiplications are drop and not computed at all due to Q2 shifting.

Stage 3(MUL): Shows how 512 bit multiplication (Q3*M) is broken into 4 256 bit multiplications.

Stage 4(SUB): Computation done in this stage is R=R−R₂ where R₁=X mod b^{k+1} (part of X) and R₂=Q3*M mod b^{k+1} (part of product Q3M). Note, the final Barrett correction stage is not shown in FIG. 6.

One exemplary memory mapping for the microcode instruction set described above is depcted in Appendix A. The mapping is devised in such a way to eliminate memory contention and maximize pipeline stage usage. In one embodiment, memory space M is 4K bits wide and memory space R is 2K bits wide.

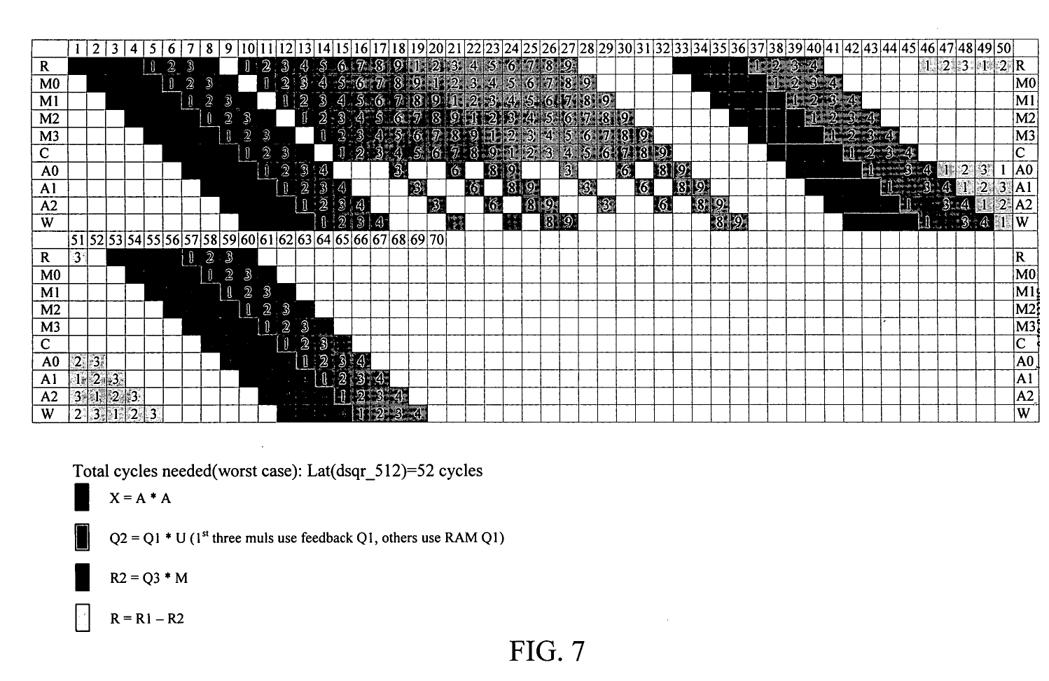

FIG. 7 shows different pipeline stages in an exemplary PKE core for the following exemplary RSA CRT operation:
R(Read)→M0(Mul0)→M1(Mul1)→M2(Mul2)→M3(Mul3)→C(CSA)→A0(Ad d0)→A1(Add1)→A2(Add2)→W(Write)

As shown, it take 52 cycles for one iteration of two symmetric exponentiation operations. Above pipelines only show one iteration (loop body) with squaring computations. These are the main microcodes for RSA CRT methods. Its formula is:
R₀=R₀*R₀ mod′P; R₁=R₁*R₁ mod′Q

Note: “mod′” means only partial Barrett modular reduction is applied. Different drawing patterns are used for different operations within same modulus based operations, similar drawing pattern is used to distinguish two symmetric operations (i.e., P based and Q based). Top line denotes cycle number. From left to right, each entry is one microcode at that cycle. From top to down, the sequencing of the microcode through different pipeline stages is depicted.

Microcode sequence (some of details are omitted for clarity):

| 1 | MUL0 | X₀[0]R₀[0]R₀[0] | | | |
|---|---|---|---|---|---|
| 2 | MAC2 | X₀[1]R₀[0]R₀[1] | | | |
| 3 | MAC0 | X₀[2]R₀[1]R₀[1] | | | |
| 4 | ADD1 | X₀[3] | | | |
| 5 | MUL0 | X₁[0]R₁[0]R₁[0] | | | |
| 6 | MAC2 | X₁[1]R₁[0]R₁[1] | | | |
| 7 | MAC0 | X₁[2]R₁[1]R₁[1] | | | |
| 8 | ADD1 | X₁[3] | | | |
| 9 | NOP | | | | |
| 10 | MUL0 | Q3₀[−2] | Q1₀[0] | Uₚ[2] | (Q3₀[−2] = Q2₀[0]) |
| 11 | MAC9 | Q3₀[−2] | Q1₀[1] | Uₚ[1] | (Q3₀[−2] = Q2₀[0]) |
| 12 | MAC1 | Q3₀[−2] | Q1₀[2] | Uₚ[0] | (Q3₀[−2] = Q2₀[0]) |
| 13 | MAC8 | Q3₀[−1] | Q1₀[0] | Uₚ[3] | (Q3₀[−1] = Q2₀[1]) |
| 14 | MAC9 | Q3₀[−1] | Q1₀[1] | Uₚ[2] | (Q3₀[−1] = Q2₀[1]) |
| 15 | MAC1 | Q3₀[−1] | Q1₀[2] | Uₚ[1] | (Q3₀[−1] = Q2₀[1]) |
| 16 | MAC8 | Q3₀[0] | Q1₀[1] | Uₚ[3] | (Q3₀[0] = Q2₀[2]) |
| 17 | MAC1 | Q3₀[0] | Q1₀[2] | Uₚ[2] | (Q3₀[0] = Q2₀[2]) |
| 18 | MAC4 | Q3₀[1] | Q1₀[2] | Uₚ[3] | (Q3₀[1] = Q2₀[3]) |
| 19 | MUL0 | Q3₁[−2] | Q1₁[0] | U_{q}[2] | (Q3₁[−2] = Q2₁[0]) |
| 20 | MAC9 | Q3₁[−2] | Q1₁[1] | U_{q}[1] | (Q3₁[−2] = Q2₁[0]) |
| 21 | MAC1 | Q3₁[−2] | Q1₁[2] | U_{q}[0] | (Q3₁[−2] = Q2₁[0]) |
| 22 | MAC8 | Q3₁[−1] | Q1₁[0] | U_{q}[3] | (Q3₁[−1] = Q2₁[1]) |
| 23 | MAC9 | Q3₁[−1] | Q1₁[1] | U_{q}[2] | (Q3₁[−1] = Q2₁[1]) |
| 24 | MAC1 | Q3₁[−1] | Q1₁[2] | U_{q}[1] | (Q3₁[−1] = Q2₁[1]) |
| 25 | MAC8 | Q3₁[0] | Q1₁[1] | U_{q}[3] | (Q3₁[0] = Q2₁[2]) |
| 26 | MAC1 | Q3₁[0] | Q1₁[2] | U_{q}[2] | (Q3₁[0] = Q2₁[2]) |
| 27 | MAC4 | Q3₁[1] | Q1₁[2] | U_{q}[3] | (Q3₁[1] = Q2₁[3]) |
| 28-32 | NOP | | | | |
| 33 | MUL0 | R2₀[0] | Q3₀[0] | P[0] | |
| 34 | MAC8 | R2₀[1] | Q3₀[0] | P[1] | |
| 35 | MAC1 | R2₀[1] | Q3₀[1] | P[0] | |
| 36 | MAC0 | R2₀[2] | Q3₀[1] | P[1] | |
| 37 | MUL0 | R2₁[0] | Q3₁[0] | Q[0] | |
| 38 | MAC8 | R2₁[1] | Q3₁[0] | Q[1] | |
| 39 | MAC1 | R2₁[1] | Q3₁[1] | Q[0] | |
| 40 | MAC0 | R2₁[2] | Q3₁[1] | Q[1] | |
| 41-45 | NOP | | | | |
| 46 | SUB0 | R₀[0] | R1₀[0] | R2₀[0] | |
| 47 | SUBC | R₀[1] | R1₀[1] | R2₀[1] | (write to R₀[1] |
| | | | | | [255:0]) |
| 48 | SUBC | R₀[1] | R1₀[2] | R2₀[2] | (write to R₀[1] |
| | | | | | [260:256]) |
| 49 | SUB0 | R₁[0] | R1₁[0] | R2₁[0] | |
| 50 | SUBC | R₁[1] | R1₁[1] | R2₁[1] | (write to R₁[1] |
| | | | | | [255:0]) |
| 51 | SUBC | R₁[1] | R1₁[2] | R2₁[2] | (write to R₁[1] |
| | | | | | [260:256]) |

As shown above and in FIG. 7, the pipeline is optimized so that as many operations as possible can be overlapped.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for calculating a reciprocal R of an integer N of length k*256 bit, the method comprising:
determining a required precision;
determining a number of iterations T responsive to the required precision;
normalizing N into d so that N=d*2^{-s}*2^{K}, 1≦d<2 (d=1.b₁b₂b₃ . . . b_{K}), where N=(Nₖ₋₁Nₖ₋₂ . . . N₀)_{b} is modulus before normalization, d is an intermediate result of modulus after normalization, and s is normalize shift count;
obtaining initial approximation of 1/d=R[0], where R is reciprocal at different iterations of a modified Newton Raphson operation;
refining reciprocal approximation by the modified Newton Raphson operation using ones complements;
truncating final iteration result R[T] responsive to the required precision;
denormalizing R[T]; and
outputting the reciprocal R.

2. The method of claim 1, wherein the initial approximation of 1/d is obtained from a midpoint reciprocal table.

3. The method of claim 2, wherein the initial approximation of 1/d has a 9-bit precision.

4. The method of claim 1, wherein d includes at least 512-bit fraction.

5. The method of claim 1, wherein the number of iterations T is determined from a relative error table and the required precision.

6. The method of claim 1, wherein the required precision is 1x for normal divisions used in Extended Euclid GCD modular inverse algorithm in a public key system.

7. The method of claim 1, wherein the required precision is 2x for most public key operations.

8. The method of claim 1, wherein the required precision is 3x for a RSA CRT operation.

9. The method of claim 1, wherein the required precision is 4x for a DSA operation.

10. A system for accelerating calculation of a reciprocal of an integer N comprising:
an input buffer for receiving an input including a long integer N and a required precision;
a parser for decoding the received input to determine the size of the integer N, the number of iterations of a modified Newton Raphson operation, and the number of truncations for each iteration;
a lookup table for obtaining an initial reciprocal seed 1/d;
a memory for storing the input integer N, intermediate normalized d of N, and intermediate and final results of the reciprocal calculation in pre-assigned locations;
a microcode generation module for generating microcode on the fly responsive to the required precision, the stored integer N, and the intermediate results;
an execution unit for executing the generated microcode in a single-cycle based pipeline structure to generate the reciprocal of the integer N; and
an output buffer for outputting the reciprocal.

11. The system of claim 10, wherein the execution unit comprises a first execution module for generating partial normalization shifting result, and a second execution module for arithmetic operations including multiplying and accumulating.

12. The system of claim 10, wherein d includes at least 512-bit fraction.

13. The system of claim 10, wherein the number of iterations T is determined from a relative error table and the required precision.

14. The system of claim 10, wherein the required precision is 1x for normal divisions used in Extended Euclid GCD modular inverse algorithm in a public key system.

15. The system of claim 10, wherein the required precision is 2x for most public key operations.

16. The system of claim 10, wherein the required precision is 3x for a RSA CRT operation.

17. The system of claim 10, wherein the required precision is 4x for a DSA operation.

18. A system for accelerating calculation of a reciprocal of an integer N comprising:
means for receiving an input including a long integer N and a required precision;
means for decoding the received input to determine the size of the integer N, the number of iterations of a modified Newton Raphson operation, and the number of truncations for each iteration;
means for obtaining an initial reciprocal seed 1/d;
means for storing the input integer N, intermediate normalized d of N, and intermediate and final results of the reciprocal calculation in pre-assigned locations;
means for generating microcode on the fly responsive to the required precision, the stored integer N, and the intermediate results;
means for executing the generated microcode in a single-cycle based pipeline structure to generate the reciprocal of the integer N; and
means for outputting the reciprocal.

19. The system of claim 18, wherein the initial approximation of 1/d is obtained from a midpoint reciprocal table.

20. The system of claim 18, wherein d includes at least 512-bit fraction.
